(19) United States
(12) Patent Application Publication
(10) Pub. No.: US 2015/0123938 A1
(43) Pub. Date: May 7, 2015

(54) ELECTRONIC DEVICE FOR PROXIMITY DETECTION, A LIGHT EMITTING DIODE FOR SUCH ELECTRONIC DEVICE, A CONTROL UNIT FOR SUCH ELECTRONIC DEVICE, AN APPARATUS COMPRISING SUCH ELECTRONIC DEVICE AND AN ASSOCIATED METHOD

(71) Applicant: Libor Gecnuk, Prostejov (CZ)

(72) Inventor: Libor Gecnuk, Prostejov (CZ)

(73) Assignee: FREESCALE SEMICONDUCTOR, INC., Austin, TX (US)

(21) Appl. No.: 14/410,164

(22) PCT Filed: Jul. 6, 2012
(86) PCT No.: PCT/IB2012/053472

§ 371 Date: Dec. 22, 2014

(51) Int. Cl. G06F 3/041; G06F 3/042; G06F 3/044; G01V 3/00

(52) U.S. Cl. CPC G06F 3/0416; G01V 3/00; G06F 3/0421; G06F 3/044; G06F 2203/04106; G06F 2203/04108
USPC 345/174

(57) ABSTRACT

An electronic device for proximity detection is described. The electronic device has a first light emitting diode and a control unit. The control unit has a first terminal electrically connected to the anode of the first light emitting diode and a second terminal electrically connected the cathode of the first light emitting diode. The control unit is arranged to operate the first light emitting diode in a plurality of modes, the plurality of modes comprising at least a drive mode and a capacitive sense mode. The control unit is arranged to, in the drive mode, operate the first light emitting diode via the first terminal and the second terminal in forward bias condition for operating the first light emitting diode to generate light. The control unit is arranged to, in the capacitive sense mode, performing a capacitance measurement on at least one terminal of the first terminal and the second terminal.

### FIELD OF THE INVENTION

This invention relates to an electronic device for proximity detection, a light emitting diode for such electronic device, a control unit for such electronic device, an apparatus comprising such electronic device and an associated method.

### BACKGROUND OF THE INVENTION

Touch sensitive devices are widely used in many applications to receive a user input and allow a user to control the application. Touch sensitive devices are available in different types. One type of touch sensitive devices comprises capacitive touch sensors. A capacitive touch sensor generally uses a conductive layer, further referred to as a capacitive layer, of which a capacitance is measured. The capacitive layer may be covered with a dielectric layer to, e.g., protect the capacitive layer against environmental influences. The capacitance of the capacitive layer varies when, for example, a human finger comes in a proximity of the capacitive touch sensor. A measurement of the capacitance may thus be used to detect, or at least estimate, the presence of a human finger in its proximity. Such detection, or estimation, may be used as a user input to the application. For example, a touch of a human finger of an external surface of the dielectric layer may be detected, or estimated, from an increase in capacitance of a capacitive layer positioned at the opposite surface of the dielectric layer and used as a user input to control an application. A wide variety of methods to measure the capacitance is known in the art, all with their specific merits and drawbacks. An example of a method is, e.g., given in US patent application US 2011/0267079 A1 by the applicant.

Many capacitive touch sensors are used in combination with another device arranged to provide a signal to the user when a touch of a human finger is detected to inform the user thereof. Hereto, known systems may have a light emitting diode positioned besides a capacitive touch sensor, or, when the capacitive touch sensor is transparent for light emitted by the light emitting diode, behind the capacitive touch sensor. Further, some known systems comprise a plurality of such capacitive touch sensors to allow a user to select between different user inputs. Other known systems comprise a capacitive touch sensor with a spatial sensitivity, e.g., having multiple capacitive layer regions in a spatial layout.

### SUMMARY OF THE INVENTION

The present invention provides an electronic device for proximity detection, a light emitting diode for such electronic device, a control unit for such electronic device, an apparatus comprising such electronic device and an associated method as described in the accompanying claims.

Specific embodiments of the invention are set forth in the dependent claims.

These and other aspects of the invention will be apparent from and elucidated with reference to the embodiments described hereinafter.

### BRIEF DESCRIPTION OF THE DRAWINGS

Further details, aspects and embodiments of the invention will be described, by way of example only, with reference to the drawings. Elements in the figures are illustrated for simplicity and clarity and have not necessarily been drawn to scale.

FIG. 1a-FIG. 10 schematically show examples of embodiments of electronic devices for proximity detection and apparatuses comprising such electronic devices; and

FIG. 11 schematically shows an example of a method according to an embodiment.

### DETAILED DESCRIPTION OF THE PREFERRED EMBODIMENTS

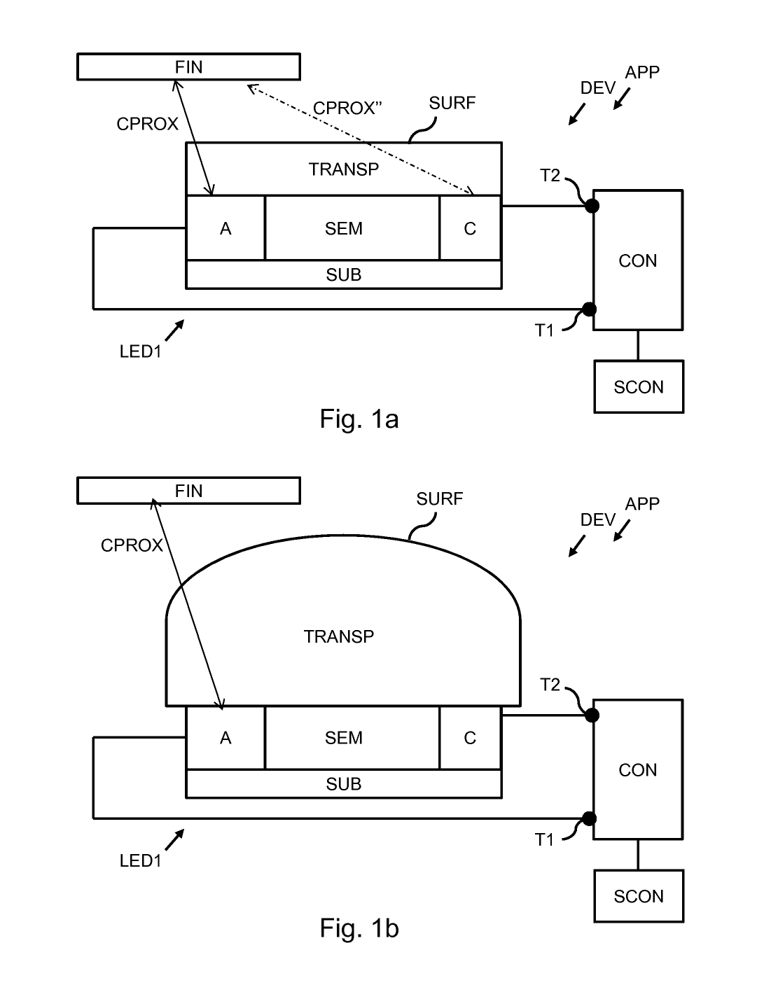

FIG. 1a schematically shows an example of an apparatus APP comprising an electronic device DEV for proximity detection. The apparatus APP further comprises a system controller SCON. The system controller SCON is arranged to cooperate with the electronic device DEV, and more specifically a control unit CON thereof, to estimate a proximity of a human finger FIN from a capacitance measurement. The influence of the proximity of the finger on the electronic device DEV is indicated with arrow CPROX. The system controller SCON is further arranged to perform a further action in response to the estimation of a proximity of a human finger FIN. The further action may e.g. relate to controlling one or more actuators (not shown). The electronic device DEV may thus be used as a user input device to control the apparatus APP.

The electronic device DEV comprises a first light emitting diode LED1 and the control unit CON. The first light emitting diode LED1 has an anode A and a cathode C. The anode A and cathode C are connected to a semiconductor structure SEM, for example a p−n junction forming a diode. The anode A, semiconductor structure SEM, and cathode C may, as schematically indicated, be arranged substantially side-by-side on a substrate SUB and covered with a transparent dielectric layer TRANSP. An external surface SURF of transparent layer TRANSP is exposed to the environment and may be touched by the human finger FIN. The transparent layer TRANSP may be integrally formed as part of a semiconductor manufacturing process of manufacturing the first light emitting diode LED1.

The control unit CON has a first terminal T1 electrically connected to the anode A of the first light emitting diode LED1 and a second terminal T2 electrically connected the cathode C of the first light emitting diode LED1. The control unit CON is arranged to operate the first light emitting diode LED1 in a plurality of modes. The plurality of modes comprises at least a drive mode and a capacitive sense mode.

The control unit CON is arranged to, in the drive mode, operate the first light emitting diode LED1 via the first terminal T1 and the second terminal T2 in forward bias condition for operating the first light emitting diode LED1 to generate light. The control unit CON may hereto e.g. be arranged to provide a fixed current level, or may monitor the generated light from detecting a part of the generated light and control the current level in dependence on the detected part.

The control unit CON is further arranged to, in the capacitive sense mode, perform a capacitance measurement on at least one terminal of the first terminal T1 and the second terminal T2. Hereto, the control unit CON may be arranged to, in the capacitive sense mode, operate the first light emitting diode LED1 in reverse bias. Alternatively, the control unit CON may be arranged to, in the capacitive sense mode, operate the first light emitting diode LED1 in forward bias using a drive current at such a low level that substantially no light is generated when operating in the capacitive sense mode.

The control unit CON may be arranged to, in the capacitive sense mode, perform the capacitance measurement on one terminal selected from the first terminal T1 and the second terminal T2. For example, the control unit CON may be arranged to perform the capacitance measurement on the first terminal T1, thereby arranged to effectively measure the capacitance of the anode A as indicated with arrow CPROX. In an alternative example, the control unit CON may be arranged to perform the capacitance measurement on the second terminal T2, thereby arranged to effectively measure the capacitance of the cathode C as indicated with arrow CPROX′.

The control unit CON may be arranged to, in the capacitive sense mode, perform the capacitance measurement using a differential measurement between the first terminal T1 and the second terminal T2. Hereby, the control units may be arranged to effectively measure the differential capacitance between the anode A and the cathode C. Such differential measurement may provide an improved accuracy of the measured capacitance and/or may be more robust against influences from the environment.

The control unit itself, or the system controller SCON in cooperation with the control unit CON, may be arranged to estimate a proximity of a human finger FIN in dependence on the capacitance measurement. The control unit CON may for example estimate that the human finger FIN is in close proximity to or in contact with the external surface SURF if the capacitance measurement corresponds to a capacitance above a certain threshold level, whereas the control unit CON may estimate that no human finger is in proximity or contact if the capacitance measurement corresponds to a capacitance below a certain threshold level. The skilled person will appreciated that suitable threshold levels may e.g. be derived from the physical layout of the electronic device DEV and the dielectric thickness of the transparent layer TRANS.

The electronic device DEV may thus provide light generation and capacitive sensing using a single pair of connections between the electronic device DEV and the control unit CON, i.e., via the first terminal T1 connected to the anode A and the second terminal T2 connected to the cathode C. Hereby, the number of connections needed for the two functions of light generation and proximity sensing via capacitive sensing may be reduced compared to prior art systems where different electrical connections the capacitive measurement are used for the two functions.

The plurality of modes may further comprise a light sense mode. The control unit CON may be arranged to, in the light sense mode, operate the first light emitting diode LED1 via the first terminal T1 and the second terminal T2 in reverse bias condition and detect a photocurrent generated by the first light emitting diode LED1. Hereby, the control unit CON may, from the detection of the photocurrent, obtain a measure of an amount of light that is incident on the first light emitting diode of the electronic device DEV. For example, if the electronic device DEV has a single light emitting diode LED1, said amount may e.g. smaller when a finger is in proximity to the electronic device due to the finger forming an obstruction to incident light and blocking part of the incident light. The light sense mode may also be referred to as optical sense mode.

A second proximity sensing may hereby be provided as an optical proximity sensing. A combination of the first proximity sensing based on the capacitive measurement and the second proximity sensing based on the detected photocurrent may improve the robustness of proximity sensing compared to one of them alone. The combination may e.g. relate to a correlation.

The control unit CON may further be arranged to operate the first light emitting diode LED1 in the drive mode in dependence on the proximity estimation. The control unit CON may hereby provide a feedback to the user that an input by his finger has been detected. The system controller SCON may be arranged to, for providing user feedback, control the control unit CON with drive conditions for the drive mode.

FIG. 1b schematically shows another example of an apparatus APP comprising an electronic device DEV for proximity detection. Where no differences are described, any references, structural features and functional features of the example shown in FIG. 1b may correspond to the same references, structural features and functional features as shown and/or described with reference to FIG. 1a.

The electronic device DEV shown in FIG. 1b differs from the electronic device DEV shown in FIG. 1a in that the transparent dielectric layer TRANSP is replaced by a transparent dielectric body TRANSP′. An external surface SURF of transparent body TRANSP′ is exposed to the environment and may be touched by the human finger FIN. The transparent body TRANSP′ may e.g. be a plastic lens arranged to shape the angular distribution of light generated in the LED1. The transparent body TRANSP′ may be shaped to improve the efficiency of out-coupling of light out of the semiconductor structure SEM. The transparent body TRANSP′ may be in direct contact with the arrangement of the anode A, the semiconductor structure SEM, and the cathode C. The transparent body TRANSP′ may be permanently attached (for example glued) to the arrangement. One or more further layers (not shown) may be provided between the transparent body TRANSP′ and the arrangement of the anode A, the semiconductor structure SEM, and the cathode C, e.g., by being arranged on a face of the transparent body TRANSP′ facing said arrangement.

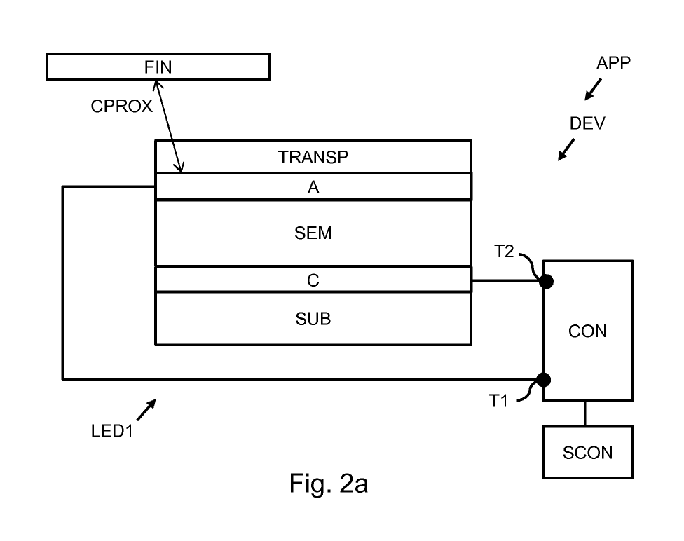

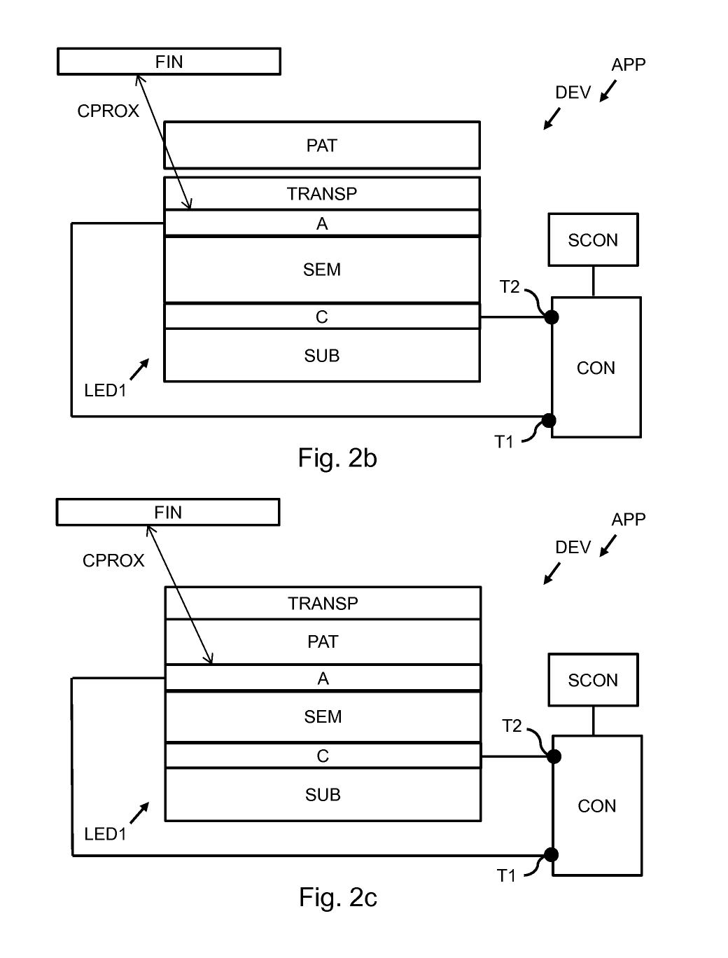

FIG. 2a-FIG. 2c schematically show further examples of an apparatus APP comprising an electronic device DEV for proximity detection. Where no differences are described, any references, structural features and functional features of the examples shown in FIG. 2a-FIG. 2c may correspond to the same references, structural features and functional features as shown and/or described with reference to FIG. 1a.

FIG. 2a shows an electronic device DEV comprising a first light emitting diode LED1 and the control unit CON. The electronic device DEV of FIG. 2a differs from the electronic device DEV of FIG. 1a in that the anode A, semiconductor structure SEM and cathode C of the first light emitting diode LED1 are not arranged in a side-by-side manner, but as a layered structure of a substrate SUB, a cathode layer C provided on the substrate, a semiconductor structure SEM on the cathode layer C and an anode layer A on the semiconductor structure SEM The layered structure is covered with a transparent dielectric layer TRANSP. An external surface SURF of transparent layer TRANSP is exposed to the environment and may be touched by the human finger FIN. The anode A is at least partly transparent for light generated in the semiconductor structure SEM. The anode A is connected to the first terminal T1 of the control unit CON.

The control unit CON may be arranged in any corresponding manner as described with reference to FIG. 1a.

The control unit CON may be arranged to, in the capacitive sense mode, perform a capacitance measurement on the first terminal T1, connected to the anode A. Hereby, the anode A may be used as a capacitive layer.

In an alternative arrangement, the positions of anode A and cathode C of the layered structure are interchanged, such that the cathode C is arranged in between the semiconductor substrate and the transparent layer TRANSP. Herein, the control unit CON may be arranged to, in the capacitive sense mode, perform a capacitance measurement on the second terminal T2 connected to the cathode C. Hereby, the cathode C may be used as a capacitive layer.

FIG. 2b shows a further example of an electronic device DEV. The example shown in FIG. 2b differs from that shown in FIG. 2a in that a patterned layer PAT is arranged at an external side of the transparent layer TRANSP. The patterned layer PAT may comprise a pattern of transparent and non-transparent regions, which provide, when viewed by a user, information to the user. The pattern may e.g. correspond to a number, whereby the electronic device DEV may be used as a capacitive touch button allowing a user to effectively input the number. A plurality of such electronic devices DEV, each with a different pattern in the respective patterned layer PAT to indicate different numbers, may thus be as, for example, a capacitive touch key pad. The patterned layer PAT may e.g. comprise a dielectric layer or a metal layer. The transparent regions may correspond to a region of transparent material or a cut-out. The non-transparent regions may correspond to, for example, a region of absorbing material or a region of reflective material.

FIG. 2c shows a further example of an electronic device DEV. The example shown in FIG. 2c differs from that shown in FIG. 2b in that the patterned layer PAT is arranged in between the transparent layer TRANSP and the anode A.

The patterned layer PAT may also be used in combination with an arrangement as shown in FIG. 1a.

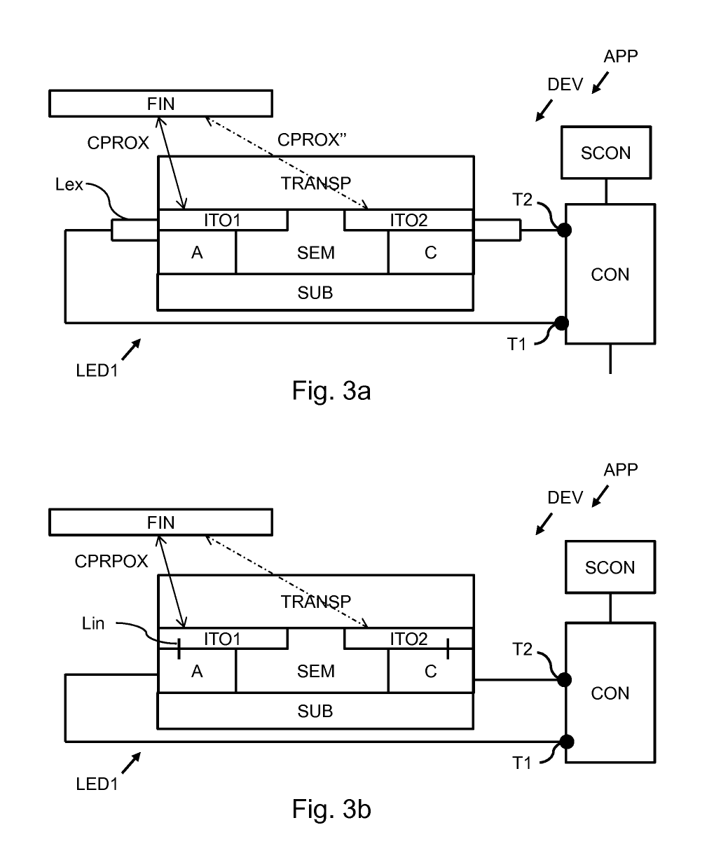

FIG. 3a-FIG. 3b schematically show further examples of an apparatus APP comprising an electronic device DEV for proximity detection. Where no differences are described, any references or features shown in FIG. 3a-FIG. 3b may correspond to the same references or features described with reference to FIG. 1a.

The electronic device DEV shown in FIG. 3a differs from that shown in FIG. 1a in that the electronic device further comprises a first conductive layer region ITO1 electrically connected to the anode A of the first light emitting diode LED1. The first conductive layer region ITO1 may be an indium-tin-oxide (ITO) layer region, or another conductive layer region such as a metal layer region. The first conductive layer region ITO1 is arranged, at least partly, in between the anode A and the transparent layer TRANSP. The first conductive layer region ITO1 may have a larger area than the anode A. The first conductive layer region ITO1 may hereby provide an increased measure of capacitance when performing the capacitance measurement on the first terminal T1. The first conductive layer region ITO1 may be integrally formed with the first light emitting diode LED1, or may, for example, be formed on the interior surface of the transparent layer TRANSP. In the example of FIG. 3a, the electrical connection between the first conductive layer region ITO1 and the anode A may be formed by a first external connection Lex, such as a conductive wire.

The electronic device DEV shown in FIG. 3a further comprises a second conductive layer region ITO2 electrically connected to the cathode C of the first light emitting diode LED1. The second conductive layer region ITO2 may be an indium-tin-oxide (ITO) layer region, or another conductive layer region such as a metal layer region. The second conductive layer region ITO2 is arranged, at least partly, in between the cathode C and the transparent layer TRANSP. The second conductive layer region ITO2 may have a larger area than the cathode C. The second conductive layer region ITO2 may hereby provide an increased measure of capacitance when performing the capacitance measurement on the second terminal T2. The second conductive layer region ITO2 may be integrally formed with the first light emitting diode LED1, or may, for example, be formed on the interior surface of the transparent layer TRANSP. In the example of FIG. 3a, the electrical connection between the second conductive layer region ITO2 and the cathode C may be formed by a second external connection.

The electronic device DEV shown in FIG. 3b differs from that shown in FIG. 3a in that the electrical connection between the first conductive layer region ITO1 and the anode A is formed by a first internal connection Lin, such as a conductive via through an intermediate layer (not shown) or as provided by a direct contact between the first conductive layer region ITO1 and the anode A. Likewise is the electrical connection between the first conductive layer region ITO1 and the anode A is formed by a second internal connection.

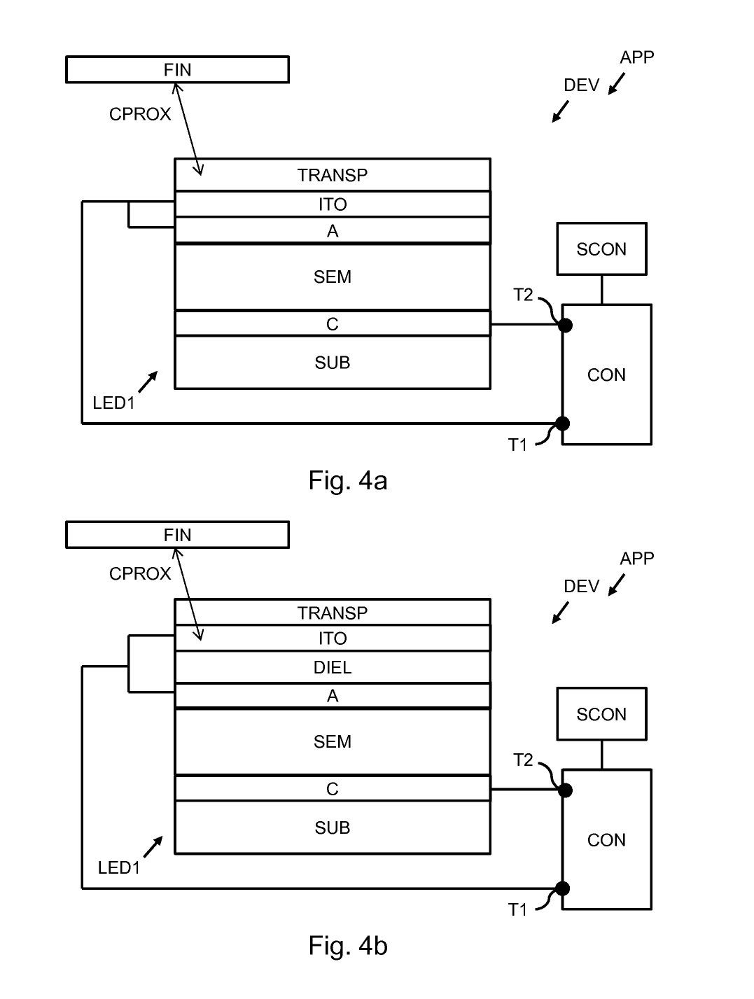

FIG. 4a-FIG. 4b schematically show further examples of an apparatus APP comprising an electronic device DEV for proximity detection. Where no differences are described, any references or features shown in FIG. 4a-FIG. 4b may correspond to the same references or features described with reference to FIG. 2a-FIG. 2b.

The electronic device DEV shown in FIG. 4a differs from that shown in FIG. 2a in that the electronic device further comprises a first conductive layer ITO1 electrically connected to the anode A of the first light emitting diode LED1. The first conductive layer ITO1 is arranged in between the anode A and the transparent layer TRANSP.

The electronic device DEV shown in FIG. 4b differs from that shown in FIG. 4a in that the electronic device further comprises a dielectric layer DIEL arranged in between the first conductive layer ITO1 and the anode A. In such arrangement, a measurement current provided via the first terminal T1 may distribute between the anode A and the first conductive layer ITO1 for optimized measurement.

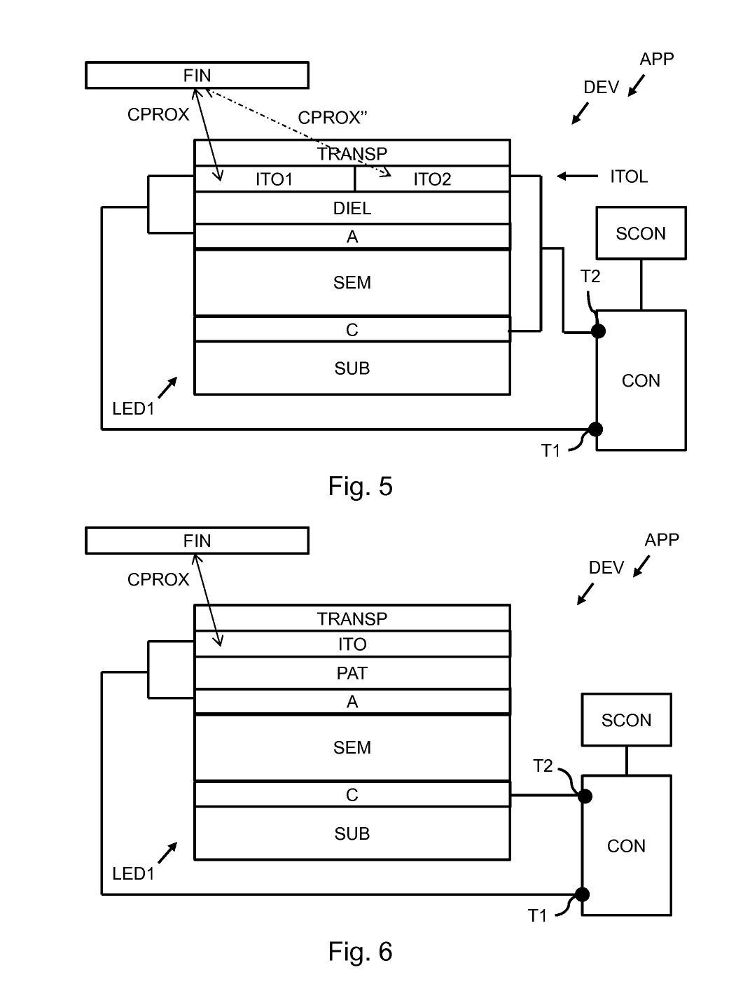

FIG. 5 schematically show further examples of an apparatus APP comprising an electronic device DEV for proximity detection. Where no differences are described, any references or features shown in FIG. 5 may correspond to the same references or features described with reference to FIG. 4a-FIG. 4b.

The example shown in FIG. 5 shows a patterned transparent conductive layer ITOL. The patterned transparent conductive layer ITOL comprises a first conductive layer region ITO1 electrically connected to the anode A of the first light emitting diode and a second conductive layer region ITO2 electrically connected to the cathode C of the first light emitting diode LED1. The first conductive layer region ITO1 and the second conductive layer region ITO2 are isolated from each other.

The control unit CON may be arranged to, in the capacitive sense mode, perform the capacitance measurement using a differential measurement between the first terminal T1 and the second terminal T2. Hereby, the control unit may be arranged to effectively measure the differential capacitance between the first conductive layer region ITO1 connected to the anode A and the second conductive layer region ITO1 connected to the cathode C. Such differential measurement may provide an improved accuracy of the measured capacitance and/or may be more robust against influences from the environment.

FIG. 6 schematically show further examples of an apparatus APP comprising an electronic device DEV for proximity detection. Where no differences are described, any references or features shown in FIG. 6 may correspond to the same references or features described with reference to FIG. 4b.

The example shown in FIG. 6 differs from that shown in FIG. 4 in that the dielectric layer DIEL of FIG. 4 is replaced by a patterned layer PAT. The patterned layer PAT may comprise a pattern of transparent and non-transparent regions, which provide, when viewed by a user, information to the user. The patterned layer PAT may further have similar features as described with referenced to FIG. 2a.

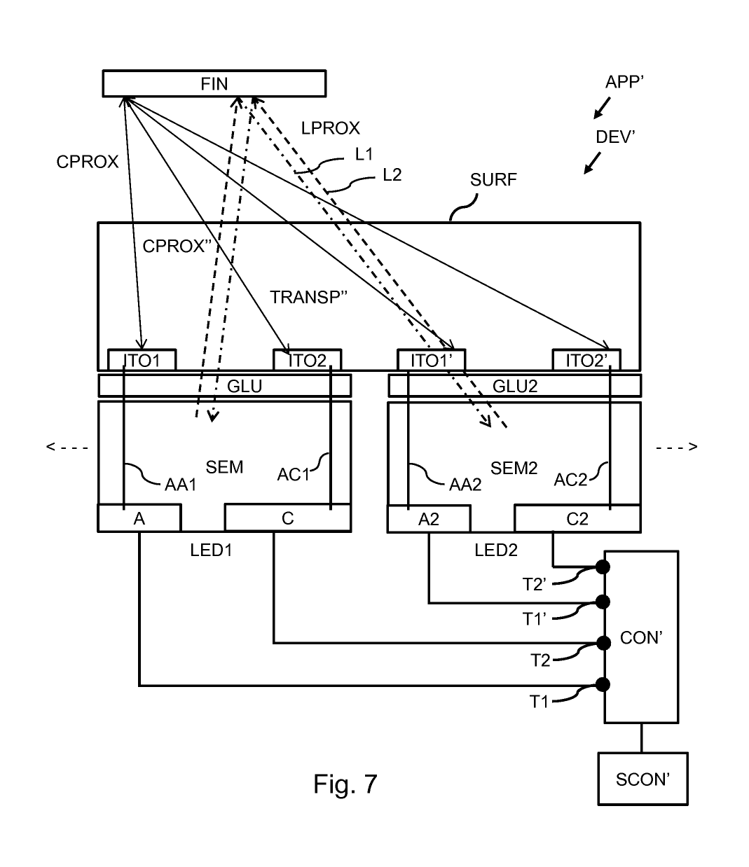

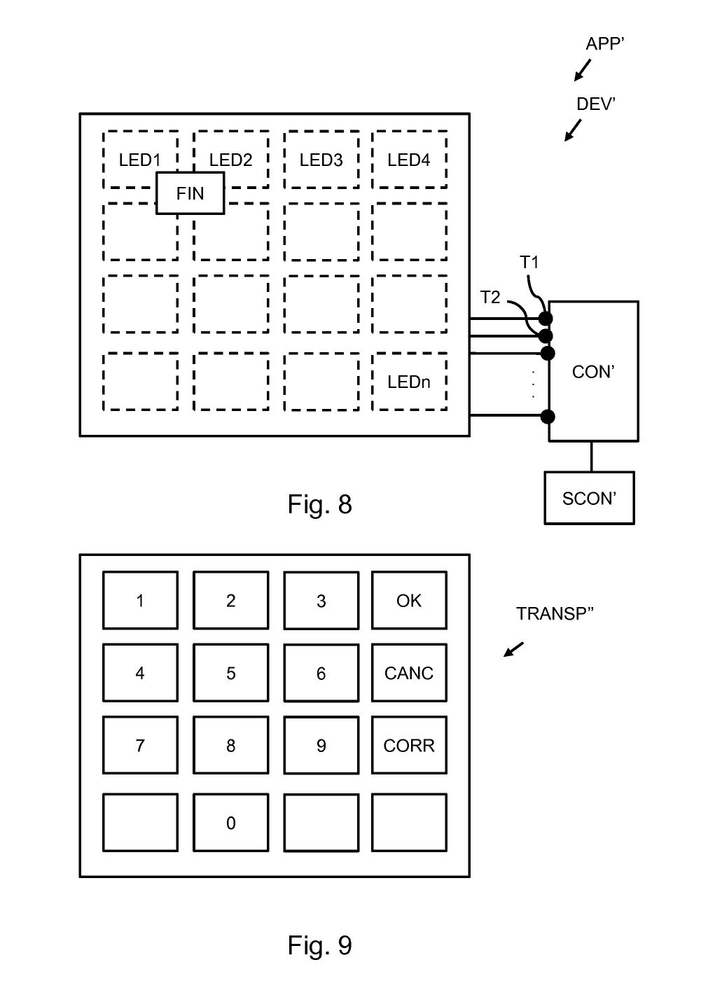

FIG. 7-FIG. 8 schematically shows another examples of an apparatus APP′ comprising an electronic device DEV′ for proximity detection. The apparatus APP further comprises a system controller SCON′. The system controller SCON′ is arranged to cooperate with the electronic device DEV′, and more specifically a control unit CON′ thereof, to estimate a proximity of a human finger FIN from a capacitance measurement. The system controller SCON′ may further be arranged to estimate a position of the human finger FIN from the capacitance measurement.

The electronic device DEV′ of FIG. 7 and FIG. 8 has a plurality of light emitting diodes LED1, LED2, LED3, LED4, . . . , LEDn arranged in a spatial layout, for example in a two-dimensional matrix layout as indicated in FIG. 8. The plurality of light emitting diodes LED1, . . . , LEDn is glued on one side of a transparent plate TRANSP″, further referred to as the backside. Each light emitting diode has an anode and a cathode electrically connected to respective terminals if the control unit CON′. FIG. 7 shows a first light emitting diode LED1 and a second light emitting diode LED2 of the plurality of light emitting diodes LED1, LED2, LED3, LED4, . . . , LEDn.

The first light emitting diode LED1 has an anode indicated with A and a cathode indicated with C. The second light emitting diode LED2 has an anode indicated with A2 and a cathode indicated with C2.

A plurality of conductive layer regions ITO1, ITO2, ITO1′, ITO2′ is arranged in the backside of the transparent plate TRANSP′ in a layout substantially corresponding to the spatial layout of the plurality of light emitting diodes LED1, . . . , LEDn. The anodes and cathodes of each of the light emitting diodes are connected to a respective conductive layer region. FIG. 7 shows that the anode A of the first light emitting diode LED1 is electrically connected to a first conductive layer region ITO1 with conductive connection AA1, the cathode C of the first light emitting diode LED1 is electrically connected to a second conductive layer region ITO2 with conductive connection AC1, the anode A2 of the second light emitting diode LED2 is electrically connected to a first further conductive layer region ITO1′ with conductive connection AA2, and the cathode C2 of the second light emitting diode LED2 is electrically connected to a second further conductive layer region ITO2′ of the plurality of conductive layer regions ITO1, ITO2, ITO2′ with conductive connection AC2.

A first terminal T1 of the control unit CON′ is electrically connected to the anode A of the first light emitting diode LED1 and a second terminal T2 of control unit CON′ is electrically connected the cathode C of the first light emitting diode LED1. A first further terminal T1′ of the control unit CON′ is electrically connected to the anode A2 of the second light emitting diode and a second further terminal T2′ of the control unit CON′ is electrically connected the cathode C2 of the second light emitting diode LED2. The control unit CON′ is arranged to operate the first light emitting diode LED1 in a plurality of modes, the plurality of modes comprising a drive mode and a capacitive sense mode. The control unit CON′ is further arranged to operate the second light emitting diode in a plurality of modes of the second light emitting diode, the plurality of modes comprising at least a drive mode and a capacitive sense mode of the second light emitting diode. The control unit CON′ is arranged to, in the drive mode of the first light emitting diode LED1, operate the first light emitting diode LED1 via the first terminal T1 and the second terminal T2 in forward bias condition for operating the first light emitting diode LED1 to generate light. The control unit CON′ is arranged to, in the capacitive sense mode of the first light emitting diode, perform a capacitance measurement on at least one terminal of the first terminal T1 and the second terminal T2. The control unit CON′ is further arranged to, in the drive mode of the second light emitting diode, operate the second light emitting diode via the first further terminal and the second further terminal in forward bias condition for operating the second light emitting diode to generate light, and to, in the capacitive sense mode of the second light emitting diode, perform a capacitance measurement on at least one of the first further terminal and the second further terminal. The control unit CON′ is similarly connected to and arranged to operate the other light emitting diodes of the plurality of light emitting diodes. The control unit CON′ may thus obtain a capacitance measurement comprising a plurality of capacitance information associated with each of the plurality of light emitting diodes. The capacitance measurements may comprise differential measurements between the respective terminals, thereby providing a differential measurement reflecting the differential capacitance between two conductive layer regions ITO1, ITO2 connected to respective anodes and cathodes of respective light emitting diodes. The control unit CON′, or the system controller SCON′, may be arranged to determine position information from the plurality of capacitance information by, e.g., determining which capacitance information corresponds to the largest capacitance corresponding to the closest proximity of the finger FIN. The capacitance measurement may thus be used to obtain a first proximity measure.

The plurality of modes of any light emitting diode may further comprise a light sense mode of the respective light emitting diode. Thus, the plurality of modes of the first light emitting diode may further comprise a light sense mode. The control unit CON′ may be arranged to, in the light sense mode, operate the first light emitting diode LED1 via the first terminal T1 and the second terminal T2 in reverse bias condition and detect a photocurrent generated by the first light emitting diode LED1. Further, the plurality of modes of the second light emitting diode may further comprise a light sense mode of the second light emitting diode. The control unit CON′ may be arranged to, in the light sense mode of the second light emitting diode, operate the second light emitting diode via the first further terminal and the second further terminal in reverse bias condition and detect a photocurrent generated by the second light emitting diode.

The control unit CON′ may be arranged to operate a light emitting diode in the light sense mode while none of the other light emitting diodes is in a drive mode, to hereby detect an obstruction by a finger in the proximity to obtain a second proximity measure. Herein, the control unit CON′ may be arranged to operate the first light emitting diode LED1 in the light sense mode while operating the second light emitting diode LED2 to not generate light.

In an alternative example, the control unit CON′ may be arranged to operate the first light emitting diode LED1 in the light sense mode while operating the second light emitting diode LED2 in the drive mode of the second light emitting diode. Further, the control unit CON′ may be arranged to operate the second light emitting diode LED2 in its light sense mode while operating the first light emitting diode LED1 in its drive mode. This mode of operation is schematically indicated in FIG. 7. (For simplicity, any refraction is not indicated in FIG. 7.) FIG. 7 shows a first light ray L1, emitting by the first light emitting diode LED1 during its drive mode, and reflected by a finger FIN in a proximity of the transparent plate TRANSP′ in an area corresponding to the position of the first light emitting diode. Light ray L1 is reflected towards the second light emitting diode LED2, where the light ray L1 may generate a photocurrent which may be detected by the control unit CON′. Likewise may light ray L2, emitted by the second light emitting diode LED2, generate a photocurrent in the first light emitting diode LED1 if light ray L2 is reflected by the finger FIN. A proximity of a finger, indicated with LPROX, may thus be estimated from the generated photocurrents in the light emitting diodes. Further, a position information of the finger may be estimated from the generated photocurrents.

The control unit CON′ or the system controller SCON may further be arranged to combine the capacitance information and the light sense information to estimate a proximity of a finger, and to estimate a position of a finger in a proximity.

It will be appreciated that alternative examples similar to that shown in FIG. 7 may be designed wherein, for example, only the anode or only the cathode is connected to conductive layer regions on the transparent plate TRANSP″, or where other elements are used similar to those described with reference to FIG. 1a-FIG. 6.

For example, the transparent plate TRANSP″ may carry a pattern, or the device may further comprise a patterned layer having a pattern, wherein the pattern corresponds to visual information as positions according to the layout of the plurality of LEDs. An example is shown in FIG. 9. FIG. 9 shows an example of a transparent plate TRANSP″ carrying a pattern suitable for the layout shown in FIG. 8. The pattern reflects a keypad layout with value indicators corresponding to numerical values 0-9, and control values OK for indicating a confirmation of an input, CANC for indicating a cancellation of an input process and CORR for indicating a correction of an input. The system controller SCON may use the electronic device DEV as an input device to, e.g., take a security code input such as a personal identification (PIN) number. The system controller SCON may perform further actions on response of receiving the PIN number, such as, in an ATM machine, checking the PIN number against a secured reference on an identification card, operating card holder actuators to release the identification card and operating cash dispense actuators to release money. The pattern may alternative reflect e.g. a linear layout of level indicators for an elevator, wherein the system controller SCON may use the electronic device DEV as an input device to obtain the level where a user of the elevator wants to go to, and operate an elevator actuator to move the elevator accordingly. The light emitting diodes may be used to confirm the user input by, e.g., driving the corresponding light emitting diode to light up after an input is detected. Further, non-limiting and non-exhaustive examples of an apparatus according to exemplary embodiments are kitchen appliances, keyboards for a computer, handheld devices and gaming devices where the electronic device may provide kitchen appliance control, keyboard input, handheld control and gesture control.

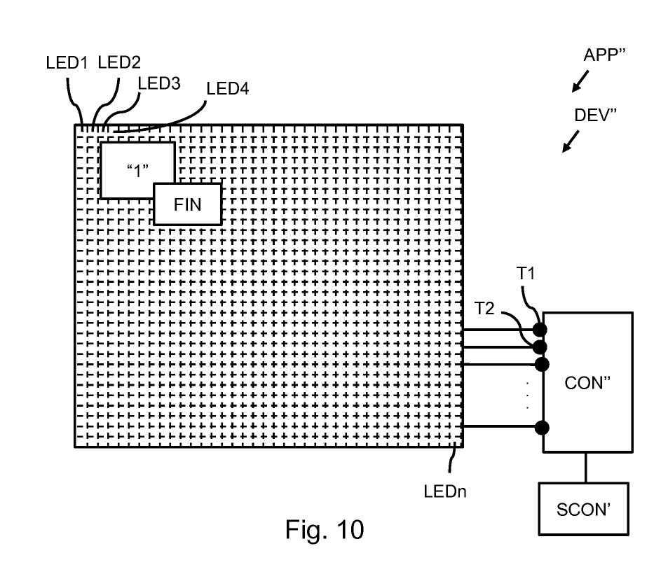

FIG. 10 schematically shows another example of an apparatus APP″ comprising an electronic device DEV″ for proximity detection.

The electronic device DEV″ of FIG. 10 has a plurality of light emitting diodes LED1, LED2, LED3, LED4, . . . , LEDn arranged in a two-dimensional matrix layout as indicated in FIG. 10. The electronic device DEV″ of FIG. 10 differs from the electronic device DEV′ shown in FIG. 7 and FIG. 8 in that the plurality of light emitting diodes LED1, LED2, . . . , LEDn is operable to provide proximity sensing at a different resolution compared to the native resolution provided by the light emitting diodes LED1, LED2, LED3, LED4, . . . , LEDn themselves. Hereto, the plurality of light emitting diodes LED1, LED2, . . . , LEDn may be arranged in a large-resolution matrix. For example, the plurality of light emitting diodes LED1, LED2, . . . , LEDn in FIG. 10 may be arranged in a matrix of more than 100 rows and more than 100 columns, for example in a 180×120 matrix, a 360×240 matrix, a 640×480 matrix, a 800×600 matrix, a 1024×600 matrix, a 1024×720 matrix, a 1280×800 matrix, or more than 1000 rows and 1000 columns, for example in a 1680×1050 matrix, a 1920×1080 matrix, a 1920×1200 matrix, or a matrix of an even higher resolution. The plurality of light emitting diodes LED1, LED2, . . . , LEDn may have been formed on the transparent plate TRANSP′. The plurality of light emitting diodes LED1, LED2, . . . , LEDn may have been formed on a substrate, where the substrate may further comprise conductors for connecting the anodes and anodes of the plurality of light emitting diodes LED1, LED2, . . . , LEDn to respective terminals of the control unit CON′. The substrate and the plurality of light emitting diodes LED1, LED2, . . . , LEDn may hereby form e.g. an active matrix display. The light emitting diodes LED1, LED2, . . . , LEDn may be inorganic semiconductor LEDs or organic LEDs.

The transparent plate TRANSP″ of electronic device DEV″ may be similar to that shown in FIG. 9 and may have a fixed pattern PAT, such as the pattern showing a key pad layout as shown in FIG. 9. Alternatively, the transparent plate TRANSP″ of electronic device DEV″ may be a non-patterned plate.

The plurality of light emitting diodes LED1, LED2, LED3, LED4, . . . , LEDn may be operated to display one or more images in the drive mode, thereby operating the plurality of light emitting diodes LED1, LED2, LED3, LED4, . . . , LEDn as an electronic display. The images may be controlled by the control unit CON″. The images may be dynamically adjustable.

The plurality of light emitting diodes LED1, LED2, LED3, LED4, . . . , LEDn may be operated to form one or more capacitive patterns in the capacitive sense mode. The plurality of light emitting diodes LED1, LED2, LED3, LED4, . . . , LEDn may hereby be operated to provide suitably shaped capacitive sense electrodes. The capacitive pattern may be controlled by the control unit CON″.

The capacitive pattern may e.g. correspond to groups of neighbouring light emitting diodes of the plurality of light emitting diodes LED1, LED2, LED3, LED4, . . . , LEDn, such as groups formed by blocks of 2×2, 2×3, 3×3, 8×8, or any other suitable number of columns×number of rows of light emitting diodes. The capacitive pattern may correspond to regions of the image where the plurality of light emitting diodes are operated as an electronic display. The capacitive pattern may correspond to regions of the pattern in the transparent plate where the transparent plate comprises a pattern (as in FIG. 9). For example, the capacitive pattern may be formed by grouping the light emitting diodes LED1, LED2, LED3, LED4, . . . , LEDn at positions corresponding to the key pad region indicating value ‘1’. Capacitive patterns obtained from grouping several light emitting diodes of the plurality of light emitting diodes allows to effectively increase the size of the capacitive sense electrodes used in the capacitive sense mode from the size of the capacitive sense electrode of a single light emitting diode to the cumulative size of all light emitting diodes in the group associated with the key pad region. The sensitivity and/or robustness of the capacitive measurement may hereby be improved. The capacitive pattern may be dynamically adjustable in size and/or shape allowing capacitive measurements at different effective sense electrode shapes and/or sizes.

The plurality of light emitting diodes LED1, LED2, LED3, LED4, . . . , LEDn may be operated to form one or more optical sense patterns in the light sense mode. The plurality of light emitting diodes LED1, LED2, LED3, LED4, . . . , LEDn may hereby be operated to provide suitably shaped optical sense electrodes. The optical sense pattern may be controlled by the control unit CON″. The optical sense pattern may e.g. correspond to groups of neighbouring light emitting diodes of the plurality of light emitting diodes LED1, LED2, LED3, LED4, . . . , LEDn, such as groups formed by blocks of 2×2, 2×3, 3×3, 8×8, or any other suitable number of columns×number of rows of light emitting diodes. The optical sense patterns may be controlled and used in a similar manner as described for the capacitive sense patterns. Hereby, a summed photocurrent obtained from adding the photocurrents from all light emitting diodes in a group associated with the one or more optical sense patterns may be used in the light sense mode. The sensitivity and/or robustness of the optical sensing may hereby be improved. The optical sense patterns may e.g. correspond to the capacitive sense patterns. The optical sense patterns may e.g. correspond light emitting diodes arranged in between light emitting diodes of associated capacitive sense patterns; for example, the capacitive sense pattern may comprise light emitting diodes arranged at even-numbered columns while the optical sense patterns may comprise light emitting diodes arranged at odd-numbered columns. The optical sense pattern may be dynamically adjustable in size and/or shape allowing photocurrent measurements at different effective sense electrode shapes and/or sizes.

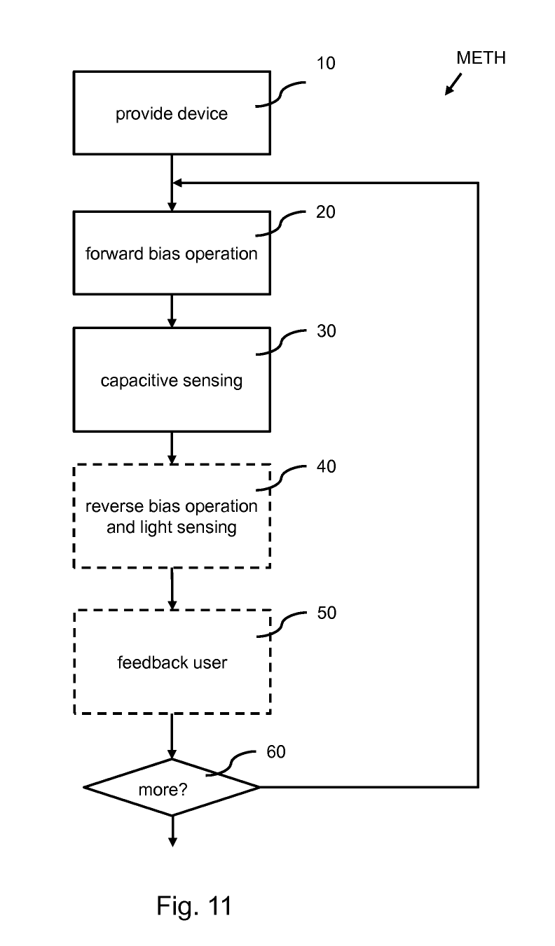

FIG. 11 schematically shows an example of a method METH of operating a first light emitting diode LED1 having an anode A and a cathode C. The method comprises providing a first light emitting diode LED1 or an electronic device having a first light emitting diode LED1. The method further comprises operating the first light emitting diode LED1 via a first terminal T1 electrically connected to the anode A of the first light emitting diode LED1 and a second terminal T2 electrically connected the cathode C of the first light emitting diode LED1 in a plurality of modes, the plurality of modes comprising at least a drive mode and a capacitive sense mode. The plurality of modes may further comprise a light sense mode. The method comprises, in the drive mode, operating 20 the first light emitting diode LED1 via the first terminal T1 and the second terminal T2 in forward bias condition for operating the first light emitting diode LED1 to generate light. The method comprises, in the capacitive sense mode, performing 30 a capacitance measurement on at least one of the first terminal T1 and the second terminal T2. The method may further comprise, in the light sense mode, operating 40 the first light emitting diode via the first terminal and the second terminal in reverse bias condition and detecting a photocurrent generated by the first light emitting diode. The method may further comprise operating a second light emitting diode in a plurality of modes of the second light emitting diode. The method may further comprise estimating a proximity of a human finger (FIN) in dependence on the capacitance measurement. The method may further comprise giving 50 a feedback response to a user upon an estimation of a proximity of a human finger FIN.

The method may, as indicated in FIG. 11, comprise performing a sequence of operating 20 the first light emitting diode in the drive mode, operating 30 the first light emitting diode in the capacitive sense mode and—if the plurality of modes comprises a light sense mode-operating 40 the first light emitting diode in the light sense mode. The method may comprise performing the sequence a plurality of times. The method may comprise determining 60 whether a further sequence need to be performed. The method may further comprise operating a second light emitting diode in a plurality of modes of the second light emitting diode. The method may further comprise estimating a proximity of a human finger (FIN) in dependence on the capacitance measurement.

The skilled person will appreciate that drive conditions, capacitive sense conditions and optical sense conditions may differ depending on the type of light emitting diode(s) LED1, LED2, the type and thickness of the transparent layer TRANSP′, the estimation sensitivity required, any position accuracy required and possibly other parameters. Further, the skilled person will appreciate that a wide variety of methods for capacitance measurement and light sensing exists.

The light emitting diode may e.g. be a semiconductor LED, e.g. a low-power semiconductor LED, such as of a type generally referred to as an indicator LED or of any other type operable in the drive mode at a drive current in a range of 1-10 mA, a medium-power semiconductor LED operable at a drive current range of 10 mA-500 mA, or a high-power semiconductor LED operable at a drive current range of 100 mA-5 A. In the capacitive sense mode, a reverse or forward current may be a factor of 100-1000 smaller (in absolute value) than the forward current in the drive mode, such as 0.1 pA-100 pA in the capacitive sense mode for a low-power semiconductor LED. In the light sense mode, a reverse current may be a factor of 100-100,000 smaller (in absolute value) than the forward current in the drive mode, such as 100 pA-10 pA in the light sense mode for a low-power semiconductor LED. A suitable semiconductor LED may for example have an anode and/or cathode size in a range of 0.01 mm2-1 mm2, which may be suitable for a capacitance measurement in some applications without a transparent layer region ITO1, ITO2 (as in e.g. FIG. 1a, FIG. 1b, FIG. 2a), and/or which use a transparent layer region ITO1, ITO2 of a larger size to increase the effective size of the capacitive layer, such as larger than 3 times the anode or cathode size, for example on a range of 3-100 times the anode or cathode size. The light emitting diode may alternatively be e.g. an organic LED (OLED) with an anode or cathode size of e.g. 1-50 cm2 and a drive current of, e.g., several μA.

The capacitive measurement may e.g. use a charge-discharge cycle using a capacitance-to-time, capacitance-to-frequency or capacitance-to-voltage conversion. A change current may e.g. be in a range of 0.1-100 μA with a charge-dischange cycle time of 0.1-1000 μs for a capacitive electrode size of e.g. 0.1-100 mm2.

The dielectric thickness of the transparent layer TRANS, transparent body TRANSP′ or transparent plate TRANSP″ may be in a range of 100 um to 2 cm, such as in a range of 100 um to 2 mm for a consumer apparatus or in a range of 1-2 cm for unbreakable glass in vandal-proof applications such as unsupervised ATMs.

In the foregoing specification, the invention has been described with reference to specific examples of embodiments of the invention. It will, however, be evident that various modifications and changes may be made therein without departing from the broader spirit and scope of the invention as set forth in the appended claims. For example, the connections may be an type of connection suitable to transfer signals from or to the respective nodes, units or devices, for example via intermediate devices. Accordingly, unless implied or stated otherwise the connections may for example be direct connections or indirect connections.

The semiconductor substrate described herein can be any semiconductor material or combinations of materials, such as gallium arsenide, silicon germanium, silicon-on-insulator (SOI), silicon, monocrystalline silicon, the like, and combinations of the above.

Because the apparatus implementing the present invention is, for the most part, composed of electronic components and circuits known to those skilled in the art, circuit details will not be explained in any greater extent than that considered necessary as illustrated above, for the understanding and appreciation of the underlying concepts of the present invention and in order not to obfuscate or distract from the teachings of the present invention.

Although the invention has been described with respect to specific conductivity types or polarity of potentials, skilled artisans appreciated that conductivity types and polarities of potentials may be reversed.

Moreover, the terms “front,” “back,” “top,” “bottom,” “over,” “under” and the like in the description and in the claims, if any, are used for descriptive purposes and not necessarily for describing permanent relative positions. It is understood that the terms so used are interchangeable under appropriate circumstances such that the embodiments of the invention described herein are, for example, capable of operation in other orientations than those illustrated or otherwise described herein.

Thus, it is to be understood that the architectures depicted herein are merely exemplary, and that in fact many other architectures can be implemented which achieve the same functionality. In an abstract, but still definite sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected,” or “operably coupled,” to each other to achieve the desired functionality.

Also, devices functionally forming separate devices may be integrated in a single physical device. For example, the control unit CON and the system controller SCON may be separate devices or integrated in a single physical device.

However, other modifications, variations and alternatives are also possible. The specifications and drawings are, accordingly, to be regarded in an illustrative rather than in a restrictive sense. For example, in any of the examples, the transparent layer TRANSP may be replaced or supplemented with a transparent body TRANSP′. Also, positions of anode A and cathode C of the light emitting diodes LED1, LED2 may be interchanged.

In the claims, any reference signs placed between parentheses shall not be construed as limiting the claim. The word ‘comprising’ does not exclude the presence of other elements or steps then those listed in a claim. Furthermore, the terms “a” or “an,” as used herein, are defined as one or more than one. Also, the use of introductory phrases such as “at least one” and “one or more” in the claims should not be construed to imply that the introduction of another claim element by the indefinite articles “a” or “an” limits any particular claim containing such introduced claim element to inventions containing only one such element, even when the same claim includes the introductory phrases “one or more” or “at least one” and indefinite articles such as “a” or “an.” The same holds true for the use of definite articles. Unless stated otherwise, terms such as “first” and “second” are used to arbitrarily distinguish between the elements such terms describe. Thus, these terms are not necessarily intended to indicate temporal or other prioritization of such elements. The mere fact that certain measures are recited in mutually different claims does not indicate that a combination of these measures cannot be used to advantage.

1. An electronic device for proximity detection, the electronic device comprising:
a first light emitting diode having an anode and a cathode;
a control unit having a first terminal electrically connected to the anode of the first light emitting diode and a second terminal electrically connected the cathode of the first light emitting diode, wherein the control unit is arranged to:
operate the first light emitting diode in a plurality of modes, the plurality of modes comprising at least a drive mode and a capacitive sense mode,
in the drive mode, operate the first light emitting diode via the first terminal and the second terminal in forward bias condition for operating the first light emitting diode to generate light, and
in the capacitive sense mode, performing a capacitance measurement on at least one terminal of the first terminal and the second terminal.

2. The electronic device according to claim 1, the control unit being arranged to, in the capacitive sense mode, perform the capacitance measurement on one terminal of the first terminal and the second terminal.

3. The electronic device according to claim 1, the control unit being arranged to, in the capacitive sense mode, perform the capacitance measurement using a differential measurement between the first terminal and the second terminal.

4. The electronic device according to claim 1, the electronic device comprising a first conductive layer region electrically connected to the anode of the first light emitting diode.

5. The electronic device according to claim 1, the electronic device comprising a second conductive layer region electrically connected to the cathode of the first light emitting diode.

6. The electronic device according to claim 1, the control unit being arranged to estimate a proximity of a human finger in dependence on the capacitance measurement.

7. The electronic device according to claim 1, the plurality of modes further comprising a light sense mode,
the control unit being arranged to, in the light sense mode, operate the first light emitting diode via the first terminal and the second terminal in reverse bias condition and detect a photocurrent generated by the first light emitting diode.

8. The electronic device according to claim 7, the control unit being arranged to estimate a proximity of a human finger in dependence on the capacitance measurement and the photocurrent.

9. The electronic device according to claim 1, the electronic device comprising a second light emitting diode,
the second light emitting diode having an anode and a cathode,
the control unit having a first further terminal electrically connected to the anode of the second light emitting diode and a second further terminal electrically connected the cathode of the second light emitting diode,
the control unit being arranged to operate the second light emitting diode in a plurality of modes of the second light emitting diode, the plurality of modes comprising at least a drive mode and a capacitive sense mode of the second light emitting diode,
the control unit being arranged to, in the drive mode of the second light emitting diode, operate the second light emitting diode via the first further terminal and the second further terminal in forward bias condition for operating the second light emitting diode to generate light, and
the control unit being arranged to, in the capacitive sense mode of the second light emitting diode, performing a capacitance measurement on at least one of the first further terminal and the second further terminal.

10. The electronic device according to claim 9, the plurality of modes of the second light emitting diode further comprising a light sense mode of the second light emitting diode,
the control unit being arranged, in the light sense mode of the second light emitting diode, operate the second light emitting diode via the first further terminal and the second further terminal in reverse bias condition and to detect a photocurrent generated by the second light emitting diode.

11. The electronic device according to claim 10, the control unit being arranged operate the first light emitting diode in the light sense mode while operating the second light emitting diode in the drive mode of the second light emitting diode.

12. (canceled)

13. (canceled)

14. (canceled)

15. (canceled)

16. A control unit for an electronic device according to claim 1, the control unit comprising a first terminal electrically connectable to an anode of the first light emitting diode and a second terminal electrically connectable a cathode of the first light emitting diode,
the control unit being arranged to operate the first light emitting diode in a plurality of modes, the plurality of modes comprising at least a drive mode and a capacitive sense mode,
the control unit being arranged to, in the drive mode, operate the first light emitting diode via the first terminal and the second terminal in forward bias condition for operating the first light emitting diode to generate light, and
the control unit being arranged to, in the capacitive sense mode, performing a capacitance measurement on at least one terminal of the first terminal and the second terminal.

17. A control unit according to claim 16, the plurality of modes further comprising a light sense mode,
the control unit being arranged, in the light sense mode, operate the first light emitting diode via the first terminal and the second terminal in reverse bias condition and detect a photocurrent.

18. A control unit according to claim 16, the control unit being connectable to a second light emitting diode and arranged to operate the second light emitting diode in a plurality of modes of the second light emitting diode.

19. (canceled)

20. The electronic device according to claim 1, the electronic device being part of an apparatus comprising a system controller, the system controller being arranged to cooperate with the control unit to estimate a proximity of a human finger from the capacitance measurement, and the system controller being arranged to perform a further action in response to the estimation of a proximity of a human finger.

21. A method of operating a first light emitting diode having an anode and a cathode, the method comprising:
operating the first light emitting diode via a first terminal electrically connected to the anode of the first light emitting diode and a second terminal electrically connected the cathode of the first light emitting diode in a plurality of modes, the plurality of modes comprising at least a drive mode and a capacitive sense mode;
in the drive mode, operating the first light emitting diode via the first terminal and the second terminal in forward bias condition for operating the first light emitting diode to generate light; and
in the capacitive sense mode, performing a capacitance measurement on at least one of the first terminal and the second terminal.

22. The method according to claim 21, the plurality of modes further comprising a light sense mode,
the method comprising, in the light sense mode, operating the first light emitting diode via the first terminal and the second terminal in reverse bias condition and detecting a photocurrent generated by the first light emitting diode.

23. The method according to claim 21, the method further comprising operating a second light emitting diode in a plurality of modes of the second light emitting diode.

24. The method according to claim 21, the method further comprising estimating a proximity of a human finger in dependence on the capacitance measurement.

25. The method according to claim 24, the method further comprising giving a feedback response to a user upon an estimation of a proximity of a human finger.
